(19) United States
(12) Patent Application Publication
(10) Pub. No.: US 2010/0323101 A1
(43) Pub. Date: Dec. 23, 2010

(54) Method for preparing surface modification coating of metal bipolar plates

(75) Inventors: Ching-Yuan Bai, Dasi Township (TW); Tse-Min Wen, Taichung City (TW); Ming-Der Ger, Dasi Township (TW); Shuo-Jen Lee, Yonghe City (TW); Po-Hsiu Chien, Banciao City (TW)

Correspondence Address: BACON & THOMAS, PLLC, 625 SLATERS LANE, FOURTH FLOOR, ALEXANDRIA, VA, 22314-1176, US

(73) Assignee: National Defense University, Bade City (TW)

(21) Appl. No.: 12/585,366

(22) Filed: Sep. 14, 2009

(30) Foreign Application Priority Data
Jun. 19, 2009 (TW) 098120601

(51) Int. Cl. H01M 4/04

(52) U.S. Cl. 427/115

(57) ABSTRACT

A method for preparing a surface modification coating of metal bipolar plates is disclosed, which comprises the following steps: providing a metal substrate; pre-treating the metal substrate by substrate processing, depositing a Ni-based alloy layer on the metal substrate, or the combination thereof to form an activated layer on the surface of the metal substrate; packing the metal substrate in a powder mixture comprising permeated master metal, an activator, and filler powders; heat-treating the metal substrate in the powder mixture to allow the permeated master metal to diffuse into the activated layer and then to form a surface modification coating. The permeation rate of the permeated master metal can be increased due to high defect concentration of the activated layer. Hence, a corrosion-resistant surface modification coating is prepared at a low temperature, and it can decrease the interface contact resistance between the metal bipolar plates and gas diffusion layers.

### BACKGROUND OF THE INVENTION

1. Field of the Invention

The present invention relates to a method for preparing a surface modification coating of metal bipolar plates. More particularly, the method is carried out by a combination of surface-activation techniques, a specific powder mixture, and low-temperature pack cementation to prepare a surface modification on metal bipolar plates. The modified metal bipolar plates are suitable for fuel cells or used as end plates for fuel cell stacks.

2. Description of Related Art

In recent years, substrates made of graphite have been generally used as bipolar plates in proton exchange membrane fuel cells (PEMFC). These graphite plates, on which various flow-field patterns are made by a milling machine, possess high corrosion resistance and good electrical conductivity. However, they have drawbacks, such as being difficult to be processed, brittle, expensive in processing, bulky, and high weight/performance ratio, and thus can not be commercially applied in mass production.

Therefore, cheap metal substrates are suggested to substitute expensive graphite bipolar plates so that costs can be dramatically lowered. Nevertheless, an acidic condition will be generated during PEMFC operation and it may corrode metal bipolar plates, resulting in increasing surface resistance of metal bipolar plates. Meanwhile, a small amount of cations in produced water, which are dissolved from corroded metal bipolar plates, would cause the contamination of the membrane electrode assembly and lead to inferior performance of PEMFC.

If surface modification coatings are formed on metal substrates, the situation of corroded metal bipolar plates can be alleviated to maintain PEMFC performance. In general, surface modification coatings of metal bipolar plates can be prepared by physical vapor deposition (PVD), chemical vapor deposition (CVD), or thermo-reactive deposition (such as pack cementation). Among them, the physical vapor deposition has shortcomings, for example, requiring expensive equipment and complex steps, and coatings formed thereby have low adhesion to substrates. In the chemical vapor deposition, substrates need to be heated at a high temperature to promote chemical reaction between substrates and gas reactants to produce desired coatings. Nevertheless, it is easy for metal substrates to distort at high temperature. Accordingly, both of physical vapor deposition and chemical vapor deposition can not be introduced into processes of bipolar plates with flow-field patterns, and the equipments of these processes are too expensive to satisfy the demand of economic mass production.

Traditional thermo-reactive deposition is performed at a high temperature of 800-1200° C., and it uses elements of Cr, V, Ti, etc. to form diffusion coatings containing the metal compounds such as metal carbides, nitrides, and borides. Thus, the thermo-reactive deposition is particularly suitable for carbon-containing steel substrates. Pack cementation is the mostly-used method of thermo-reactive deposition in this industry, and it is advantageous in low costs of equipment and preparing uniform coatings on complex-shaped workpieces. However, the high temperature of 800-1200° C. will cause variations in mechanical properties in substrates, and even create phase transition in steel substrates, thereby causing deformation of substrates. Thus, this process also does satisfy the industry demand of economic mass production.

As a result, there is an urgent need to provide a new technique cooperating with pack cementation to solve problems that the thickness of metal bipolar plates has gradually reduced and graphite bipolar plates are not suitable in the future.

### SUMMARY OF THE INVENTION

The object of the present invention is to provide a method for producing a surface modification coating on metal bipolar plates by surface-activation techniques and low-temperature pack cementation using a specific powder mixture. The surface modification coating is continuous and compact, and has good coverage and excellent adhesion to a substrate. Hence, the present invention is advantageous in surface modification of metal bipolar plates, which are suitable for fuel cells or used as end plates for fuel cell stacks.

To achieve the object, the present invention provides a method for preparing a surface modification coating of metal bipolar plates. In the method, the surface of the substrate is activated and then chromized by pack cementation at a lower temperature so that the surface modification coating can be produced on metal bipolar plates with simple processes.

Accordingly, the method of the present invention comprises the following steps: (A) providing a metal substrate; (B) pre-treating the metal substrate by substrate processing, depositing a Ni-based alloy layer on the metal substrate, or a combination thereof, to form an activated layer on the surface of the metal substrate; (C) packing the metal substrate, which has the activated layer, in a powder mixture, wherein the powder mixture comprises a permeated master metal, an activator, and filler powder; and (D) heat-treating the powder mixture and the substrate packed therein to make the permeated master metal diffuse to the activated layer to form a surface modification coating.

The aforesaid powder mixture can have the ingredients in any amount. For example, the powder mixture can comprise: the permeated master metal in an amount of 5 to 50 percent by weight; the activator in an amount of 1 to 10 percent by weight; and the filler powder in an amount of 10 to 85 percent by weight, based on a total amount of the powder mixture. Preferably, the powder mixture can comprise: the permeated master metal in an amount of 10 to 40 percent by weight; the activator in an amount of 4 to 8 percent by weight; and the filler powder in an amount of 30 to 60 percent by weight, based on a total amount of the powder mixture.

In addition to the abovementioned ingredients, the powder mixture can further comprise a refractory element, which can be molybdenum, wolfram, niobium, tantalum, an alloy thereof, or a combination thereof. The amount of the refractory element is not limited, but preferably is 5 to 25 percent by weight, based on a total amount of the powder mixture. More preferably, the refractory element is in an amount of 5 to 15 percent by weight, based on a total amount of the powder mixture. If the powder mixture containing the refractory element is used to form a surface modification coating, the pitting resistance of modification coating can be enhanced.

In the powder mixture, the permeated master metal can be chromium, nickel, an alloy thereof, and a combination thereof; the activator can be NH₄Cl, NH₄F, NH₄Br, KHF₂, NaF, or a combination thereof; and the filler powder can be metal oxides, nitrides, or carbide, for example, aluminum oxide, magnesium oxide, hafnium oxide, zirconium oxide, silicon carbide, silicon nitride, zirconium nitride, titanium nitride, or a combination thereof, but preferably is aluminum oxide.

In the abovementioned method, the surfaces of the metal bipolar plates are activated by pretreatment (step (B)) and then processed by pack cementation (step (D)) to carry out surface-modification thereon. Thus, a surface modification coating possessing good anti-corrosion characteristic can be obtained. Herein, the activated layer with high defect concentration is formed on the substrate surfaces by pretreatment, thereby allowing subsequent pack cementation to be performed at a lower temperature (about 400° C. to 800° C.) to form a surface modification coating. However, in a traditional method for preparing a surface modification coating of metal bipolar plates, because inactivated substrates are directly used in pack cementation, only a condition where pack cementation is heated to 800 to 1200° C. is sufficient to make the permeated master metal permeate into the metal substrates. By contrast, in the method of the present invention, the desired surface modification coating can be obtained at a much lower temperature since the activated layer having high defect concentration is formed on the surfaces of the substrate first.

In one aspect of the present invention, the surfaces of the metal substrate in step (B) are pretreated by rolling. Through rolling, the surfaces of the metal substrate contain a large amount of voids, dislocations, sub-boundaries, grain boundaries, and extremely high residual stress, and thus obtain high surface energy. Hence, the metal substrate can be activated by such the substrate processing. In rolling, different processing amounts are applied on the metal substrate. In the method of the present invention, the processing amount of rolling is not limited as long as the metal substrate can be surface-activated. The processing amount of rolling is preferably in a range of 25% to 80%, and more preferably in a range of 60% to 80%.

In another aspect of the present invention, the surfaces of the metal substrate are coated with a Ni-based alloy layer. The Ni-based alloy layer has a high defect concentration containing a large amount of grain boundaries, dislocations, voids, etc., and thus becomes an activated layer with a high defect concentration on the metal substrate. In the present invention, the coating of the Ni-based alloy layer can have the following advantages. First, the Ni-based alloy layer deposited on the metal substrate is composed of nanocrystals or contains a large amount of grain boundaries, dislocations, voids, etc. Thus it can be a base prior to pack cementation and benefits the permeated master metal to diffuse into substrate. Second, the Ni-based alloy layer used as an activated layer can keep the substrate from oxidation and make the surface modification coating, produced by pack cementation, more stable. If the Ni-based alloy layer further contains a small amount of aforesaid refractory elements, as a nickel-molybdenum-phosphorous alloy layer, the anti-pitting of the metal bipolar plates can be advanced. Next, the surface modification coating mainly composed of carbides and/or nitrides can be formed on the metal substrate after pack cementation when elements contained in the Ni-based alloy layer are efficiently controlled in a ranged amount. Because such the carbides and nitrides are electrically conductive ceramics, the surface modification coating can possess good anti-corrosion and reduced contact resistance to promote performance of fuel cells.

In further another aspect of the present invention, the metal substrate is processed by rolling and then coated with a nickel-molybdenum-phosphorous alloy layer to achieve pretreatment in step (B). In general, rolling can make the metal substrate have high surface energy. When rolling is performed along with the nickel-molybdenum-phosphorous alloy layer, an activated layer with much higher defect concentration can be obtained on the metal substrate.

In step (C) of the method of the present invention, the powder mixture is put in a crucible, and then the substrate is buried in the powder mixture. The substrate is completely encompassed by the powder mixture.

In the method of the present invention, a thickness of the surface modification coating can be in a range of 0.5 to 2 μm. The surface modification coating can be made of chromium-iron carbides, chromium-iron nitrides, or a combination thereof. Preferably, the surface modification coating is made of (Cr,Fe)₇C₃, (Cr,Fe)₂₃C₆, (Cr,Fe)₂N₁₋ₓ, or a combination thereof, wherein X is in a range of 0 to 1.

The method of the present invention is suitable for any technical field. Preferably, it is appropriate for preparation of metal bipolar plates for fuel cells or end plates for fuel cell stacks.

In conclusion, there are three methods of forming the activated layer in the present invention, and these methods can cooperate with refractory elements to improve anti-pitting performance of the metal substrate. Furthermore, these methods listed above can be performed on numerous metal substrates, simultaneously, and then a preferred surface modification layer can be formed on the metal substrates by pack cementation at a relatively low temperature.

Moreover, the present invention can combine substrate processing and formation of the flow channels, and carry out the pack cementation at 400 to 800° C. to ensure that no deformation of the metal substrates occurs. Likewise, a Cr-rich layer containing chromium carbide and chromium nitride and doped with other elements can be obtained in the preparation of the present invention. Thus, it is possible to efficiently promote anti-corrosion of the metal substrates. Once the modified metal substrates are used as bipolar plates for fuel cells, these fuel cells will have powerful performance and improved lifespan.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a fuel cell in the present invention;

FIG. 2 is a perspective view of a surface modification coating on a bipolar plate of the fuel cell in the present invention;

FIGS. 3A to 3C show a flowchart for preparing a surface modification coating in Example 1 of the present invention;

FIGS. 4A to 4C show a flowchart for preparing a surface modification coating in Example 2 of the present invention;

FIGS. 5A to 5D show a flowchart for preparing a surface modification coating in Example 3 of the present invention;

FIG. 6 is a graph of polarization curves of chromized surface modification coatings in Comparative Example 1 and Experimental Examples 1 to 5 of the present invention; and

FIG. 7 is a graph of contact resistance curves of chromized surface modification coatings in Comparative Example 1 and Experimental Examples 1, 4 and 5 of the present invention.

### DETAILED DESCRIPTION OF THE PREFERRED EMBODIMENT

First, as shown in FIG. 1, there is a perspective view of a fuel cell. On bipolar plates 10′ of a common fuel cell, multiple flow channels 11 are arranged to provide space for gas reacted with a membrane electrode assembly 12. The bipolar plates 10′ are metal bipolar plates, for example iron-based bipolar plates.

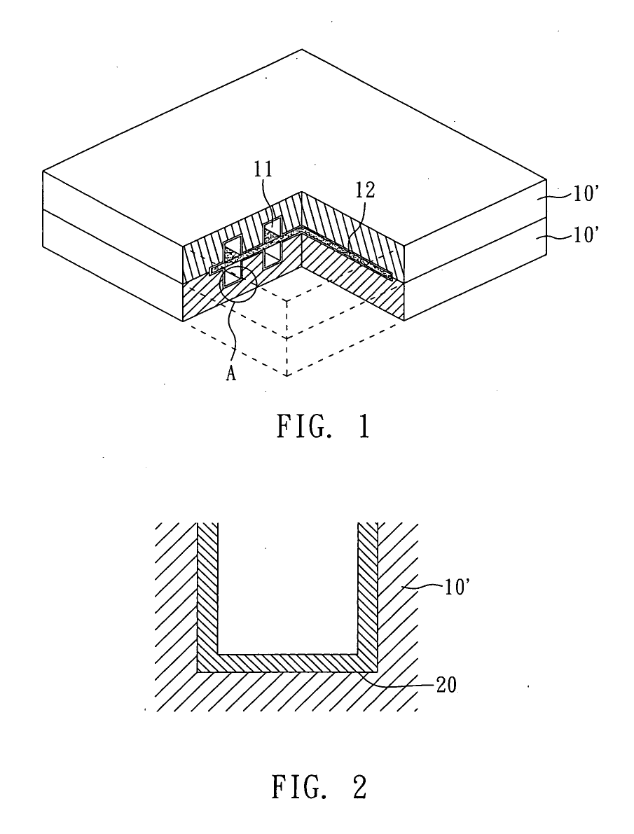

Subsequently, with reference to FIG. 2, there is an amplified view of zone A in FIG. 1. FIG. 2 shows a surface modification coating of the bipolar plates in the fuel cell of the present invention. On the surfaces of the bipolar plates 10′, a surface modification coating 20 is formed, and a thickness thereof is in a range of 0.5 to 2 μm. The surface modification coating 20 is used to increase anti-corrosion of the bipolar plates, and also prevents an acidic condition occurring during operation of fuel cells from influencing the bipolar plates.

Hereinafter, there are provided three methods where the surface modification coating 20 is formed on the surfaces of the bipolar plates by three kinds of surface pretreatment and pack cementation.

### EXAMPLE 1

### Substrate Processing and then Pack Cementation

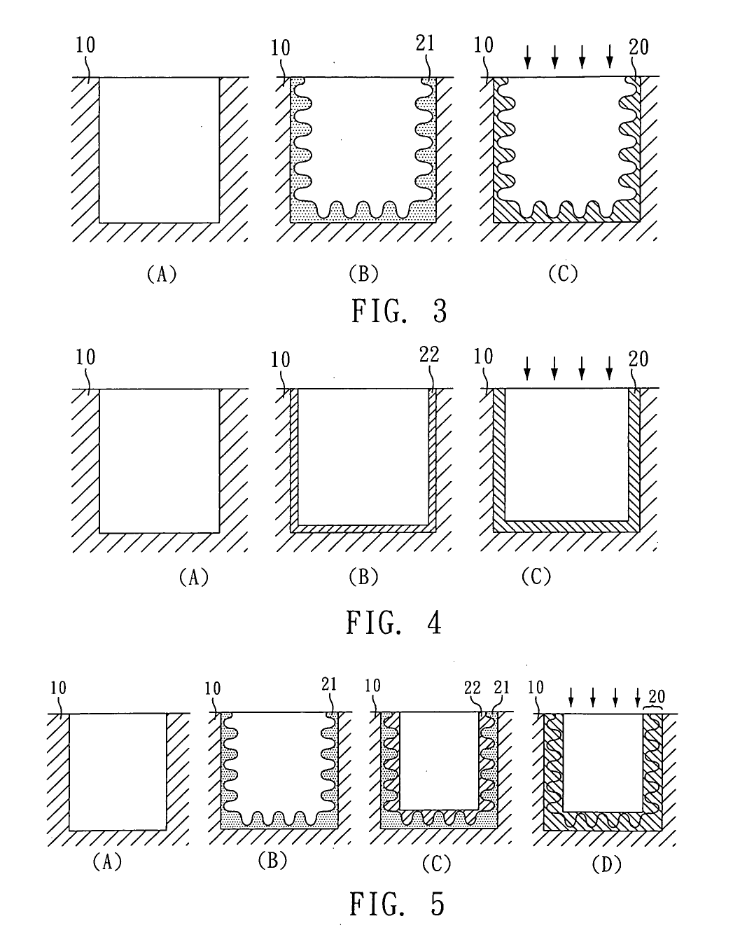

First, with reference to FIG. 3A, a metal substrate 10 is provided. As shown in FIG. 3B, the metal substrate 10 is pretreated by substrate processing such as electrical discharge machining, sand blasting, punching, stamping, and rolling. Thus, the working layer 21, which has various complex structural defects, is produced on surfaces of the metal substrate 10. Therefore, the surfaces of the metal substrate 10 exhibit extremely high surface energy.

Finally, as shown in FIG. 3C, the metal substrate 10 with the working layer 21 is embedded in a powder mixture containing permeated master metals (selectively with a refractory element), an activator, and filler powder. Pack cementation is carried out to make the permeated master metal permeate into the working layer 21, and then a surface modification coating 20 will be formed.

### EXAMPLE 2

### Coating of a Ni-Based Alloy Layer on a Metal Substrate and then Pack Cementation

First, with reference to FIG. 4A, a metal substrate 10 is provided. As shown in FIG. 4B, the metal substrate 10 is coated with a Ni-based alloy layer 22 for pretreatment. The Ni-based alloy layer 22 contains many defects such as dislocations, grain boundaries and voids, and it becomes an activated layer to activate surfaces of the metal substrate 10. In addition, nickel of the Ni-based alloy layer 22 has a good miscibility to the permeated master metal of the powder mixture so as to lower an operational temperature of the pack cementation.

Finally, as shown in FIG. 4C, the metal substrate 10 with the Ni-based alloy layer 22 is embedded in the powder mixture of Example 1. Pack cementation is carried out to make the permeated master metal permeate into the Ni-based alloy layer 22, and then a surface modification coating 20 will be formed.

### EXAMPLE 3

### Substrate Processing, Coating of a Ni-Based Alloy Layer on a Metal Substrate, and then Pack Cementation

First, with reference to FIG. 5A, a metal substrate 10 is provided. As shown in FIG. 5B, the metal substrate 10 is pretreated by machine work to form a working layer 21, and then coated with a Ni-based alloy layer 22 on the working layer 21, as shown in FIG. 5C, for completion of pretreatment which is to form an activated layer on the metal substrate 10. It can be seen that the activated layer is a combination of the working layer 21 and the Ni-based alloy layer 22. Herein, the surface energy of the metal substrate 10 can be promoted by various complex structural defects of the working layer 21 and the Ni-based alloy layer 22. Additionally, the Ni-based alloy layer 22 has a good miscibility to the permeated master metal of the powder mixture. Hence, an operational temperature of the pack cementation can be decreased by combining the working layer 21 and the Ni-based alloy layer 22. Finally, as shown in FIG. 5D, the metal substrate 10 having the activated layer (i.e. the working layer 21 together with the Ni-based alloy layer 22) is embedded in the powder mixture of Example 1. Pack cementation is carried out to make the permeated master metal permeate into the activated layer, and then a surface modification coating 20 will be formed.

Hereinafter, there are exemplified several Experimental Examples to illustrate methods for preparing a surface modification coating of bipolar metal plates in the present invention.

### COMPARATIVE EXAMPLE 1

### Chromized Surface Modification Coating Afforded by Pack Cementation on Surface-Inactivated SS430 Stainless Steel

SS430 stainless steel is polished with silicon sandpaper to #800, washed by deionized water, dried by nitrogen, and then packed in a crucible with a powder mixture containing 25 wt % chromium powder, 4 wt % ammonium chloride powder, and 71 wt % aluminum oxide powder. The crucible is put in a furnace for pack cementation for 2 hours, where the vacuum is 10⁻³ ton to prevent oxidation of the SS430 stainless steel during the pack cementation, the heating rate is 10° C./min, and the operational temperature is 700° C. so as to form a chromized surface modification coating on the SS430 stainless steel substrate.

### EXPERIMENTAL EXAMPLE 1

### Chromized Surface Modification Coating Afforded by Pack Cementation on SS430 Stainless Steel Activated by Rolling

SS430 stainless steel is pretreated by rolling (processing amount: 75%) to form a working layer (herein, serving as an activated layer), and then packed in a crucible with a powder mixture containing 20 wt % chromium powder, 9 wt % nickel powder, 4 wt % ammonium chloride powder, and 67 wt % aluminum oxide powder. The crucible is put in a furnace for pack cementation. Except for the powder mixture, other conditions in the pack cementation of the present example are the same as recited in Comparative Example 1.

### EXPERIMENTAL EXAMPLE 2

### Chromized Surface Modification Coating Afforded by Pack Cementation on SS430 Stainless Steel Coated with a Nickel-Molybdenum-Phosphorous Alloy Layer

SS430 stainless steel is coated with a nickel-molybdenum-phosphorous alloy layer (herein, used as an activated layer), and then processed by pack cementation. The pack cementation of the present example is performed under the same condition as recited in Comparative Example 1.

In the present example, since nickel-molybdenum-phosphorous layer possesses high defects as well as surface energy and nickel has good miscibility to the permeated master metal, the pack cementation can be performed at a relatively low temperature to form a surface modification coating. Furthermore, the presence of molybdenum in the chromized layer can promote anti-pitting performance of the surface modification coating.

### EXPERIMENTAL EXAMPLE 3

### Chromized Surface Modification Coating Afforded by Pack Cementation on SS430 Stainless Steel Activated by Rolling and Coated with a Nickel-Molybdenum-Phosphorous Alloy Layer

SS430 stainless steel is pretreated by rolling (processing amount: 75%) to form a working layer, and then coated with a nickel-molybdenum-phosphorous alloy layer. Hence, an activated layer consisting of the working layer and the nickel-molybdenum-phosphorous alloy layer can be afforded on the SS430 stainless steel. The pack cementation of the present example is performed under the same condition as recited in Comparative Example 1.

### EXPERIMENTAL EXAMPLE 4

### Chromized Surface Modification Coating Afforded by Pack Cementation on SS430 Stainless Steel Activated by Rolling and Coated with a Nickel-Molybdenum-Phosphorous Alloy Layer

SS430 stainless steel is pretreated by rolling (processing amount: 75%) to form a working layer, and then coated with a nickel-molybdenum-phosphorous alloy layer. Hence, an activated layer consisting of the working layer and the nickel-molybdenum-phosphorous alloy layer can be afforded on the SS430 stainless steel. Subsequently, SS430 stainless steel is processed by pack cementation with a powder mixture containing 30 wt % chromium powder, 8 wt % nickel powder, 4 wt % ammonium chloride powder, and 58 wt % aluminum oxide powder for pack cementation. Except for the powder mixture, other conditions in the pack cementation of the present example are the same as recited in Comparative Example 1.

### EXPERIMENTAL EXAMPLE 5

### Chromized Surface Modification Coating Afforded by Pack Cementation with a Powder Mixture Containing a Refractory Element on SS430 Stainless Steel Activated by Rolling

SS430 stainless steel is pretreated by rolling (processing amount: 75%) to form a working layer (herein, serving as an activated layer), and then processed by pack cementation with a powder mixture containing 18.25 wt % chromium powder, 6.75 wt % molybdenum powder, 5 wt % ammonium chloride powder, and 70 wt % aluminum oxide powder. Except for the powder mixture, other conditions in the pack cementation of the present example are the same as recited in Comparative Example 1.

Posterior to the abovementioned preparation, stainless steel bipolar plates suitable for fuel cells can be obtained, and a surface modification coating thereof is observed by scanning electron microscopy (SEM) in a plain view and in a cross-sectional view. The plain view shows that micro-particles in the surface modification coating on the stainless steel bipolar plate are composed mainly of chromium carbides, and the surface modification layer which is formed by low-temperature pack cementation has no defects such as micro-cracks, micro-voids, etc. This result means the coverage of the surface modification layer is desirable. The cross-sectional view shows that the surface modification coating has a thickness of about 1 μm.

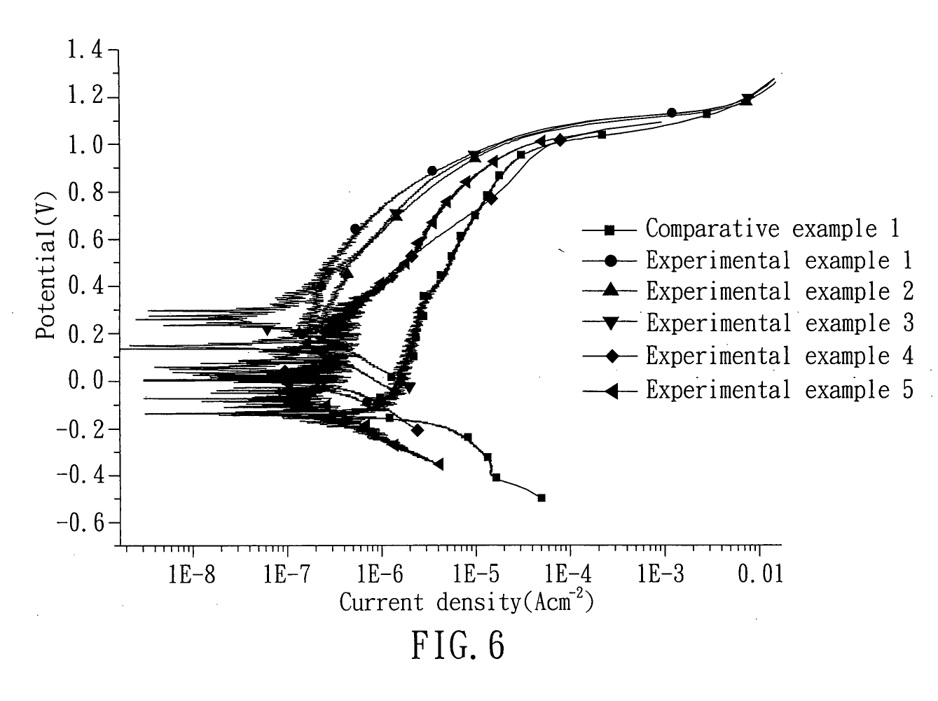

In order to determine whether the abovementioned bipolar plates are capable to apply in an acidic environment of a fuel cell, those prepared in Comparative Example 1 and Experimental Examples 1 to 5 are analyzed in a simulated operational environment of a PEMFC fuel cell (0.5 M H₂SO₄ solution at 25° C.) by a potentiodynamic polarization test. FIG. 6 shows polarization curves of the bipolar plates prepared in Comparative Example 1 and Experimental Examples 1 to 5. In addition, corrosion currents (I_{corr}) and corrosion potentials (E_{corr}) are calculated by Tafel extrapolation, as shown in Table 1. Other relative conditions also listed in Table 1.

TABLE 1

| | | | Corrosion | |
|---|---|---|---|---|
| | | | resistance results | |
| | | Type of the | I_{corr} | E_{corr} |
| Example | Powder mixture | activated layer | (A/cm²) | (V) |
| Comparative | Chromium: 25% | None | 9.21E−07 | −0.15 |
| Example 1 | NH₄Cl: 4% | | | |
| | Al₂O₃: 71% | | | |
| Experimental | Chromium: 20% | Rolling (75%) | 1.56E−07 | 0.05 |
| Example 1 | Nickel: 9% | | | |
| | NH₄Cl: 4% | | | |
| | Al₂O₃: 67% | | | |
| Experimental | Chromium: 20% | Ni/Mo/P coating | 9.1E−08 | 0.140 |
| Example 2 | Nickel: 9% | | | |
| | NH₄Cl: 4% | | | |
| | Al₂O₃: 67% | | | |
| Experimental | Chromium: 20% | Rolling (75%)+ | 5.34E−08 | 0.260 |
| Example 3 | Nickel: 9% | Ni/Mo/P coating | | |
| | NH₄Cl: 4% | | | |
| | Al₂O₃: 67% | | | |
| Experimental | Chromium: 30% | Rolling (75%)+ | 3.16E−07 | 0.02 |
| Example 4 | Nickel: 8% | Ni/Mo/P coating | | |
| | NH₄Cl: 4% | | | |
| | Al₂O₃: 58% | | | |
| Experimental | Chromium: 18.25% | Rolling (75%) | 1.12E−07 | −0.02 |
| Example 5 | Molybdenum: | | | |
| | 6.75% | | | |
| | NH₄Cl: 5% | | | |
| | Al₂O₃: 70% | | | |

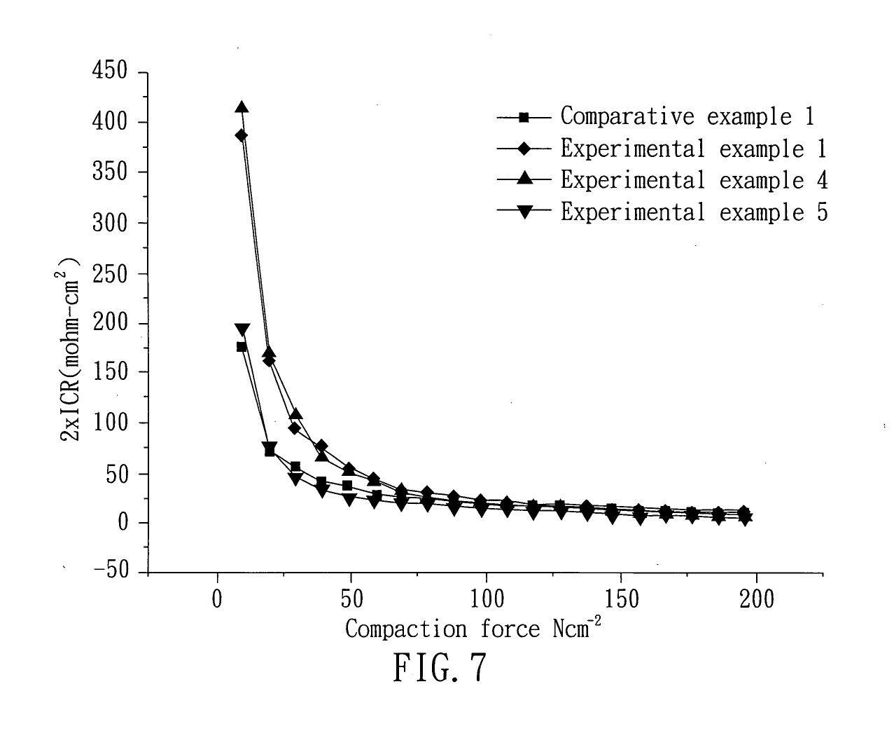

With reference to the corrosion resistance results in Table 1, when the stainless steel bipolar plates prepared in Experimental Examples 1 to 5 are compared with that prepared in Comparative Example 1, it can be seen that E_{corr} of those prepared in Experimental Examples 1 to 5 all are more positive than E_{corr} of that prepared in Comparative Example 1. In other words, it is relatively difficult to oxidize the surface modification coatings prepared in Experimental Examples 1 to 5. When fuel cells are operated at the cathodic potential of 0.6 V as shown in FIG. 6, I_{corr} of those prepared in Experimental Examples 1 to 3 are obviously reduced. I_{corr} of those prepared in Experimental Examples 4 and 5 are also reduced but in a smaller level than I_{corr} of those in Experimental Examples 1 to 3. These results demonstrate that the method of Experimental Example 4 provides good anti-pitting; that of Experimental Example 5 provides better anti-pitting; and those of Experimental Examples 1 to 3 provide best anti-pitting. The stainless steel bipolar plates prepared in Experimental Examples 1 to 5 all have sufficient anti-pitting to be used in fuels cells. FIG. 7 shows results of contact resistance of those prepared in Comparative Example 1 and Experimental Examples 1, 4 and 5, and these results exhibit that electrical conductivity of modified bipolar plates is dramatically improved.

Although the present invention has been explained in relation to its preferred embodiment, it is to be understood that many other possible modifications and variations can be made without departing from the scope of the invention as hereinafter claimed.

What is claimed is:

1. A method for preparing a surface modification coating of metal bipolar plates, comprising the following steps:
(A) providing a metal substrate;
(B) pre-treating the metal substrate by substrate processing, depositing a Ni-based alloy layer on the metal substrate, or a combination thereof, to form an activated layer on the surface of the metal substrate;
(C) packing the metal substrate, which has the activated layer, in a powder mixture, wherein the powder mixture comprises a permeated master metal, an activator, and filler powder; and
(D) heat-treating the powder mixture and the substrate packed therein to make the permeated master metal diffuse to the activated layer to form a surface modification coating.

2. The method as claimed in claim 1, wherein the powder mixture comprises: the permeated master metal in an amount of 5 to 50 percent by weight; the activator in an amount of 1 to 15 percent by weight; and the filler powder in an amount of 10 to 85 percent by weight, based on a total amount of the powder mixture.

3. The method as claimed in claim 1, wherein the powder mixture further comprises a refractory element.

4. The method as claimed in claim 3, wherein the powder mixture comprises: the permeated master metal in an amount of 5 to 50 percent by weight; the activator in an amount of 1 to 15 percent by weight; the filler powder in an amount of 10 to 85 percent by weight; and the refractory element in an amount of 5 to 25 percent by weight, based on a total amount of the powder mixture.

5. The method as claimed in claim 3, wherein the refractory element is selected from a group consisting of molybdenum, wolfram, niobium, tantalum, an alloy thereof, and a combination thereof.

6. The method as claimed in claim 1, wherein the permeated master metal is selected from a group consisting of chromium, nickel, an alloy thereof, and a combination thereof.

7. The method as claimed in claim 1, wherein the metal substrate is a metal substrate.

8. The method as claimed in claim 1, wherein the heat-treatment in step (D) is performed at a temperature of 400 to 800° C.

9. The method as claimed in claim 1, wherein the combination in step (B) is to perform the substrate processing on the metal substrate and then to form the Ni-based alloy layer on the metal substrate.
